(19) United States
(12) Patent Application Publication
(10) Pub. No.: US 2024/0016075 A1
(43) Pub. Date: Jan. 18, 2024

(54) VEHICLE KICK TO NEUTRAL CONTROL

(71) Applicant: CNH Industrial America LLC, New Holland, PA (US)

(72) Inventors: Pawel Kuros, Mount Prospect, IL (US); Nikolay Popov, New Holland, PA (US); Ramze Hasan, New Holland, PA (US); Bryan Lee Nannet, Aurora, IL (US)

(73) Assignee: CNH Industrial America LLC, New Holland, PA (US)

(21) Appl. No.: 17/866,075

(22) Filed: Jul. 15, 2022

(51) Int. Cl. A01B 69/04; F16H 59/46; F16H 59/56; F16H 59/36

(52) U.S. Cl. CPC A01B 69/008; F16H 59/46; F16H 59/56; F16H 2059/366; F16H 2300/18

(57) ABSTRACT

A vehicle control system for an agriculture vehicle. The vehicle control system includes a processing circuit including a processor and memory, the memory having instructions stored thereon that, when executed by the processor, cause the processing circuit to receive an engine speed of the agricultural vehicle, determine a difference between the engine speed and a desired engine speed, determine whether the difference is larger than an engine speed threshold, and control, responsive to the difference being larger than the engine speed threshold, the agricultural vehicle to shift to neutral.

### BACKGROUND

The present disclosure relates generally to the field of vehicle control and more particularly to a system and method for vehicle control. Operating a vehicle, such as an agricultural vehicle, under certain conditions can cause undesirable wear to an engine turbocharger or other components of the vehicle. It would be desirable to have a way to monitor the condition of the vehicle and prevent operation that may harm or cause wear to the vehicle.

### SUMMARY

One embodiment of the present disclosure relates to a vehicle control system for an agriculture vehicle. The vehicle control system includes a processing circuit including a processor and memory, the memory having instructions stored thereon that, when executed by the processor, cause the processing circuit to receive an engine speed of the agricultural vehicle, determine a difference between the engine speed and a desired engine speed, determine whether the difference is larger than an engine speed threshold, and control, responsive to the difference being larger than the engine speed threshold, the agricultural vehicle to shift to neutral.

In some embodiments, the processing circuit can receive, after the shift to neutral, a second engine speed, determine a difference between the second engine speed and the desired engine speed, determine whether the difference is larger than the engine speed threshold, and prevent, responsive to the difference being larger than the engine speed threshold, the agricultural vehicle from being shifted out of neutral.

In some embodiments, the processing circuit can present, using a user interface, an alert that the agricultural vehicle has shifted to neutral and present, using the user interface, an indication, wherein the indication includes information pertaining to the shift to neutral.

In some embodiments, the processing circuit can present, using a user interface, an alert that the agricultural vehicle has shifted to neutral, receive, using the user interface, an input to override the shift to neutral, and control, responsive to receiving the input, the agricultural vehicle to shift from neutral.

In some embodiments, the processing circuit can detect a change in the engine speed of the agricultural vehicle, determine a difference between the engine speed and the desired engine speed, and control, responsive to the difference being smaller than the engine speed threshold, the agricultural vehicle to shift from neutral.

In some embodiments, the processing circuit can receive a parameter associated with the environment of the agricultural vehicle and adjust, based on the parameter, the desired engine speed.

In some embodiments, the parameter is associated with at least one of an air pressure, an air temperature or an air humidity.

In some embodiments, the processing circuit can receive a parameter associated with the agricultural vehicle and control, responsive to receiving the parameter, the agricultural vehicle to shift to neutral.

In some embodiments, the parameter is associated with at least one of an oil temperature, a vehicle idle time or an engine temperature.

In some embodiments, the processing circuit can detect a change in the parameter and control, responsive to detecting the change in the parameter, the agricultural vehicle to shift from neutral.

Another embodiment of the present disclosure relates to a method of controlling an agricultural vehicle. The method includes receiving, by a processing circuit, an engine speed of the agricultural vehicle, determining, by the processing circuit, a difference between the engine speed and a desired engine speed, determining, by the processing circuit, whether the difference is larger than an engine speed threshold, and controlling, by the processing circuit, responsive to the difference being larger than the engine speed threshold, the agricultural vehicle to shift to neutral.

In some embodiments, the method includes receiving, by the processing circuit, after the shift to neutral, a second engine speed, determining, by the processing circuit, a difference between the second engine speed and the desired engine speed, determining, by the processing circuit, whether the difference is larger than the engine speed threshold, and preventing, by the processing circuit, responsive to the difference being larger than the engine speed threshold, the agricultural vehicle from being shifted out of neutral.

In some embodiments, the method includes presenting, by the processing circuit, using a user interface, an alert that the agricultural vehicle has shifted to neutral and presenting, by the processing circuit, using the user interface, an indication, wherein the indication includes information pertaining to the shift to neutral.

In some embodiments, the method includes presenting, by the processing circuit, using a user interface, an alert that the agricultural vehicle has shifted to neutral, receiving, by the processing circuit, using the user interface, an input to override the shift to neutral, and controlling, by the processing circuit, responsive to receiving the input, the agricultural vehicle to shift from neutral.

In some embodiments, the method includes detecting, by the processing circuit, a change in the engine speed of the agricultural vehicle, determining, by the processing circuit, a difference between the engine speed and the desired engine speed, and controlling, by the processing circuit, responsive to the difference being smaller than the engine speed threshold, the agricultural vehicle to shift from neutral.

In some embodiments, the method includes receiving, by the processing circuit, a parameter associated with the environment of the agricultural vehicle, and adjusting, by the processing circuit, based on the parameter, the desired engine speed.

In some embodiments, the method includes receiving, by the processing circuit, a parameter associated with the agricultural vehicle, and controlling, by the processing circuit, responsive to receiving the parameter, the agricultural vehicle to shift to neutral.

In some embodiments, the method includes detecting, by the processing circuit, a change in the parameter, and controlling, by the processing circuit, responsive to detecting the change in the parameter, the agricultural vehicle to shift from neutral.

Another embodiment of the present disclosure relates to a non-transitory computer-readable storage medium having instructions stored thereon that, when executed by a processor, cause the processor to receive an engine speed of the agricultural vehicle, determine a difference between the engine speed and a desired engine speed, determine whether the difference is larger than an engine speed threshold, and control, responsive to the difference being larger than the engine speed threshold, the agricultural vehicle to shift to neutral.

In some embodiments, the processor can receive, after the shift to neutral, a second engine speed, determine a difference between the second engine speed and the desired engine speed, determine whether the difference is larger than the engine speed threshold, and prevent, responsive to the difference being larger than the engine speed threshold, the agricultural vehicle from being shifted out of neutral.

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 is a block diagram of a vehicle having a vehicle control system, according to an exemplary embodiment.

FIG. 2 is a block diagram of a vehicle, according to an exemplary embodiment.

FIG. 3 is a user interface displaying a vehicle dashboard, according to an exemplary embodiment.

FIG. 4 is a user interface displaying a vehicle dashboard, according to an exemplary embodiment.

FIG. 5 is a block diagram of a method of controlling an agricultural vehicle, according to an exemplary embodiment.

### DETAILED DESCRIPTION

Referring general to the FIGURES, described herein are systems and methods of a vehicle control system. In some embodiments, the vehicle control system can facilitate control of an agricultural vehicle. The vehicle control system can receive, identify or otherwise determine parameters that are associated with the agricultural vehicle. The vehicle control system can control the agricultural vehicle to shift to neutral. The term “shift to neutral” as used herein can refer to moving, placing, altering, positioning or otherwise changing a drive mode, a current gear or any other setting of the agricultural that results in the agricultural vehicle transmission, or any similar component, being placed in neutral. This technical solution allows for the vehicle control system to seamlessly control the agricultural vehicle in order to reduce wear or damage to at least one component of the agricultural vehicle.

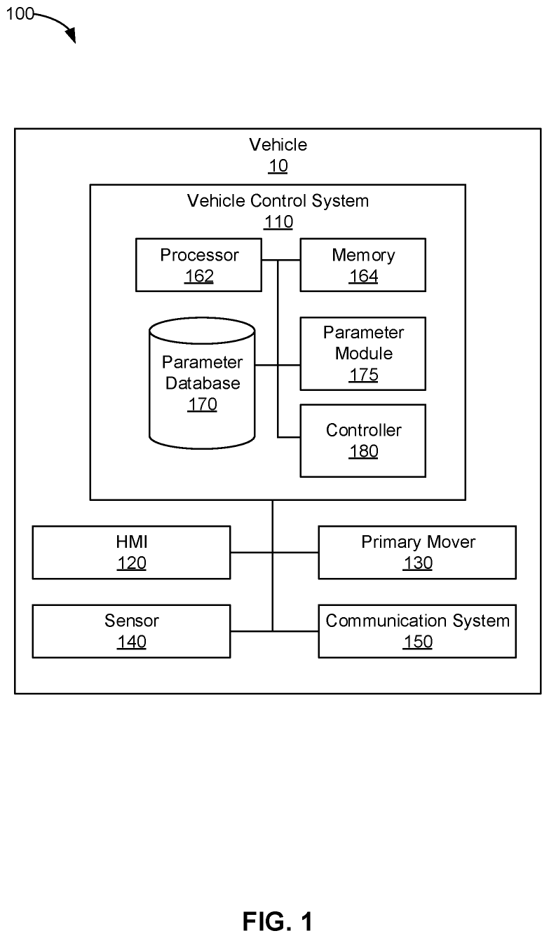

Referring to FIG. 1, a block diagram of a system 100 for controlling an agricultural vehicle is shown, according to an exemplary embodiment. The system 100 includes at least one vehicle 10. In some embodiments, the vehicle 10 is an agricultural vehicle. For example, vehicle 10 may be or include a hauling vehicle (e.g., a tractor-trailer, etc.), a harvesting vehicle (e.g., a combine harvester, etc.), and/or the like. While the system 100 of the present disclosure is described in relation to agricultural vehicles, it should be understood that the system 100 is usable with other vehicles (e.g., non-agricultural vehicles) and that such embodiments are within the scope of the present disclosure. As a non-limiting example, in a landscaping context, vehicle 10 may be a lawn mower. As another non-limiting example, in a snow-clearing context, vehicle 10 may be a winter service vehicle including a snowplow. As another non-limiting example, in a construction context, vehicle 10 may be an excavation vehicle such as a bulldozer, loader (e.g., front loader, backhoe loader, track loader, etc.), power shovel, front shovel, and/or the like. As another non-limiting example, vehicle 10 may be a utility vehicle (e.g., a truck such as a Class 1 light pickup truck, etc.), an irrigation vehicle (e.g., a linear move irrigation system, etc.), and/or the like.

The vehicle 10 can include at least one vehicle control system 110, at least one human-machine interface (HMI) 120, at least one primary mover 130, at least one sensor 140 and at least one communication system 150. In some embodiments, the vehicle control system 110 is physically located with vehicle 10. For example, the vehicle control system 110 can be or include a hardware component installed in the vehicle 10. Additionally or alternatively, part or all of the vehicle control system 110 can be located separately of the vehicle 10. For example, the vehicle control system 110 can be or include a remote processing system (e.g., a server, two or more computing systems/servers in a distributed computing implementation, a cloud-based processing system, etc.) that control the vehicle 10 remotely.

The vehicle control system 110 can include at least one processor 162, at least one memory 164, at least one parameter database 170, at least one parameter module 175 and at least one controller 180. In some embodiments, at least one of the components of the vehicle control system 110 can interact, interface or otherwise communicate with at least one additional component of the vehicle control system 110.

The processor 162 can be a general purpose or specific purpose processor, an application specific integrated circuit (ASIC), one or more field programmable gate arrays (FPGAs), a group of processing components, a processing circuit or other suitable processing components. The processor 162 can be configured to execute computer code and/or instructions stored in the memories or received from other computer readable media (e.g., CDROM, network storage, a remote server, etc.).

The memory 164 can include one or more devices (e.g., memory units, memory devices, storage devices, etc.) for storing data and/or computer code for completing and/or facilitating the various processes described in the present disclosure. The memory 164 can include random access memory (RAM), read-only memory (ROM), hard drive storage, temporary storage, non-volatile memory, flash memory, optical memory, or any other suitable memory for storing software objects and/or computer instructions. The memory 164 can include database components, object code components, script components, or any other type of information structure for supporting the various activities and information structures described in the present disclosure. The memory 164 can be communicably connected to the processor 162 and can include computer code for executing (e.g., by the processor 162) one or more processes described herein. In some embodiments, at least one of the components described herein can be stored in the memory 164 as a computer code, a software application or another form of that data can be provided and/or executed by the processor 162.

The parameter database 170 can include, store, maintain or otherwise provide data. The data can be data that is collected and provided by the sensor 140, data that is collected and provided by the HMI 120 or data that is provided by a system that is remote to the vehicle control system 110. The parameter database 170 can include at least one desired engine speed, at least one engine speed threshold and at least one vehicle operation setting. In some embodiments, the desired engine speed can be a predetermined engine speed. In some embodiments, the desired engine speed can be determined periodically in response to certain events or conditions. In some embodiments, the desired engine speed can be provided by a user associated with the vehicle 10.

The parameter module 175 can receive data from the sensor 140. In some embodiments, the data can include an engine speed of the vehicle 10. In some embodiments, the data can include at least one parameter associated with the vehicle 10. The parameter associated with vehicle 10 can include at least one of an oil temperature, a vehicle idle time or an engine temperature. In some embodiments, the data can include at least one parameter associated with the environment of the vehicle 10. The parameter associated with the environment of the vehicle 10 can include at least one of an air pressure, an air temperature or an air humidity. In some embodiments, the parameter module 175 can, using the parameter associated with the environment of the vehicle 10, adjust, modify or otherwise change the engine speed threshold.

The parameter database 170 can provide, to the parameter module 175, the desired engine speed and the engine speed threshold. The parameter module 175 can determine a difference between the engine speed and the desired engine speed. The engine speed can be larger, smaller and/or equal to the desired engine speed. In some embodiments, the parameter module 175 can determine that the difference between the engine speed and the desired engine speed is larger than the engine speed threshold. The parameter module 175, responsive to determining that the difference between the engine speed and the desired engine speed is larger than the engine speed threshold, can interface, interact or otherwise communicate with the controller 180. The parameter module 175 can provide, to the controller 180, an indication that difference between the engine speed and the desired engine speed is larger than the engine speed threshold.

The controller 180 can facilitate control of the vehicle 10. For example, the controller 180 can perform transmission control of the vehicle 10. In some embodiments, the controller 180 can, responsive to receiving the indication that the difference between the engine speed and the desired engine speed is larger than the engine speed threshold, control the vehicle 10 to shift to neutral. The controller 180 can provide, to the HMI 120, an indication that the vehicle 10 has shifted to neutral. In some embodiments, the controller 180 can provide, to the parameter module 175 and/or the sensor 140, the indication that the vehicle 10 has shifted to neutral.

The parameter module 175 can, after the shift to neutral, receive, from the sensor 140, a second engine speed. The parameter module 175 can determine a difference between the second engine speed and the desired engine speed. In some embodiments, the parameter module 175 can determine that the difference is larger than the engine speed threshold. The parameter module 175 can communicate to the controller 180 that the difference is larger than the engine speed threshold. The controller 180 can, responsive to communicating with the parameter module 175, prevent the vehicle 10 from being shifted out of neutral.

The parameter module 175 can detect a change in the engine speed of the vehicle 10. For example, the parameter module 175 can detect the change in the engine speed of the vehicle 10 by comparing a first engine speed and a second engine speed of the vehicle 10. The parameter module 175, responsive to detecting the change in the engine speed, can determine a difference between the engine speed and the desired engine speed. In some embodiments, the parameter module 175 can determine that the difference is smaller than the engine speed threshold. In some embodiments, the parameter module 175 can communicate to the controller 180 that the difference is smaller than the engine speed threshold. The controller 180 can, responsive to communicating with the parameter module 175, can control the vehicle 10 to shift from neutral.

The parameter module 175 can receive, from the parameter database 170, the vehicle operation setting. In some embodiments, the vehicle operation setting can include at least one value, range or setting associated with at least one of the parameters associated with the vehicle 10. For example, the vehicle operation setting can be that the vehicle 10 idles for a predetermined amount of time. In some embodiments, the parameter module 175 can receive, from the sensor 140, the parameter associated with the vehicle 10. For example, the parameter module 175 can receive the vehicle idle time for the vehicle 10. In some embodiments, the parameter module 175 receives the parameter associated with the vehicle responsive to an operator of the vehicle 10 performing manual transmission control. For example, the parameter module 175 can receive the parameter associated with the vehicle 10 in response to the operator selecting an icon, on the HMI 120, to perform manual transmission control. In some embodiments, the parameter module 175 can compare the vehicle idle time for the vehicle 10 and the vehicle operation setting. In some embodiments, the parameter module 175 can determine that the parameter associated with the vehicle 10 is smaller than the vehicle operation setting. In some embodiments, the parameter module 175 can communicate to the controller 180 that the parameter associated with the vehicle 10 is smaller than the vehicle operation setting. The controller 180, responsive to communicating with the parameter module 175, can control the vehicle 10 to shift to neutral.)

The parameter module 175 can detect a change in the parameter associated with the vehicle 10. For example, the parameter module 175 can detect the change in the parameter associated with the vehicle 10 by comparing a first parameter value (e.g., a first vehicle idle time) and a second parameter value (e.g., a second vehicle idle time). In some embodiments, the parameter module 175, upon detecting the change in the parameter, can compare the parameter and the vehicle operation setting. The parameter module 175 can determine that the parameter is larger than the vehicle operation setting. In some embodiments, the parameter module 175 can communicate to the controller 180 that the parameter is larger than the vehicle operation setting. In some embodiments, the controller 180, responsive to communicating with the parameter module 175 can control the vehicle 10 to shift from neutral.

The HMI 120 can facilitate user interaction with the vehicle 10 and/or the vehicle control system 110. The HMI 120 can include elements configured to present information to a user and receive user input. For example, the HMI 120 can include a display device (e.g., a graphical display, a touchscreen, etc.), an audio device (e.g., a speaker, etc.), manual controls (e.g., manual steering control, manual transmission control, manual braking control, etc.), and/or the like. The HMI 120 can include hardware and/or software components. For example, the HMI 120 can include a microphone configured to receive user voice input and a software component configured to control vehicle 10 based on the received user voice input. In some embodiments, the HMI 120 presents information associated with the operation of the vehicle 10 and/or the vehicle control system 110 to a user and facilitates user control of operating parameters. For example, the HMI 120 can display operational parameters (e.g., fuel level, seed level, penetration depth of ground engaging tools, guidance swath, etc.) on a touchscreen display and receive user control input via the touchscreen display.

In some embodiments, the HMI 120 can present an alert that the vehicle 10 has shifted to neutral. The HMI 120 can present an indication that includes information that pertains to the shift to neutral of the vehicle 10. For example, the information can include that the difference between the engine speed and the desired engine speed is larger than the engine speed threshold. In some embodiments, the HMI 120 can receive an input to override the shift to neutral. In some embodiments, the input can be an operator of the vehicle 10 selecting an icon on the touchscreen display. The HMI 120 can provide the input to override the shift to neutral to the controller 180. In some embodiments, the controller 180 can, responsive to receiving the input to override the shift to neutral, control the vehicle 10 to shift from neutral.

The primary mover 130 can generate mechanical energy to operate the vehicle 10. For example, the primary mover 130 can be or include an internal combustion engine. Additionally or alternatively, the primary mover 130 can be or include an electric motor. In some embodiments, the primary mover 130 is coupled to a frame of the vehicle 10 and configured to provide power to a plurality of tractive elements (e.g. wheels, etc.). In various embodiments, the primary mover 130 utilizes one or more fuels and/or energy storage systems (e.g., rechargeable batteries, etc.). For example, the primary mover 130 can utilize diesel, gasoline, propane, natural gas, hydrogen, lithium-ion batteries, nickel-metal hydride batteries, lithium-ion polymer batteries, lead-acid batteries, nickel-cadmium batteries, and/or the like.

The sensor 140 can monitor one or more parameters associated with the vehicle 10. For example, the sensor 140 can monitor operation of the primary mover 130 (e.g., torque, temperature, fuel level, airflow, engine speed, etc.). The sensor 140 can include an engine sensor, a transmission sensor, a temperature sensor, a location sensor, an environment sensor and/or an interface sensor.

The engine sensor can collect and or detect data that pertains to the engine of the vehicle 10. For example, the engine sensor can detect at least one of an engine speed of the vehicle 10 and/or a vehicle idle time of the vehicle 10. The transmission sensor can detect a gear of the transmission. For example, the transmission sensor can detect that the transmission of the vehicle 10 is in drive and/or reverse. The transmission sensor can also detect when the transmission is in neutral. The temperature sensor can detect a temperature associated with either the vehicle 10 and/or the environment of the vehicle 10. For example, the temperature sensor can be placed proximate to the engine of the vehicle 10 and can detect an engine temperature. Similarly, the temperature sensor can be positioned external to the vehicle 10 and can detect an ambient air temperature of the environment. The location sensor can detect a position of the vehicle 10. For example, the location sensor can determine a GPS coordinate of the vehicle 10. The environment sensor can detect at least one of an air pressure and/or an air humidity of the environment associated with the vehicle 10. In some embodiments, the environment sensor can be a sensor that is remote to the vehicle 10. The environment sensor, using the location data detected by the location sensor, can interface with a weather database to detect the air pressure and/or the air humidity.

The communication system 150 can facilitate communication between the vehicle 10 and external systems (e.g., other vehicles, a control system, sensors, etc.). The Communication system 150 can be or include wired or wireless communications interfaces (e.g., jacks, antennas, transmitters, receivers, transceivers, wire terminals, etc.) for conducting data communications within the system 100 and/or with other external systems or devices. In some embodiments, communications via the communication system 150 is direct (e.g., local wired or wireless communications). Additionally or alternatively, communications via the communication system 150 can utilize a network (e.g., a WAN, the Internet, a cellular network, a vehicle-to-vehicle network, a controller area network (CAN), etc.). For example, the vehicle control system 110 can communicate with a decision support system (DSS) using a 4G and/or 5G connection (e.g., via a 4G or 5G access point/small cell base station, etc.) and can communicate with another vehicle using a dedicated short-range communication channel (e.g., a vehicular ad-hoc network, etc.). In some embodiments, the communication system 150 facilitates vehicle-to-vehicle (V2V) and/or vehicle-to-everything (V2X) communication. For example, the communication system 150 can facilitate communication between the vehicle 10 and another vehicle using the IEEE 802.11p standard (e.g., a wireless access in vehicular environments (WAVE) vehicular communication system). In some embodiments, the vehicle 10 communicates with external systems (e.g., other vehicles, etc.) via Wi-Fi.

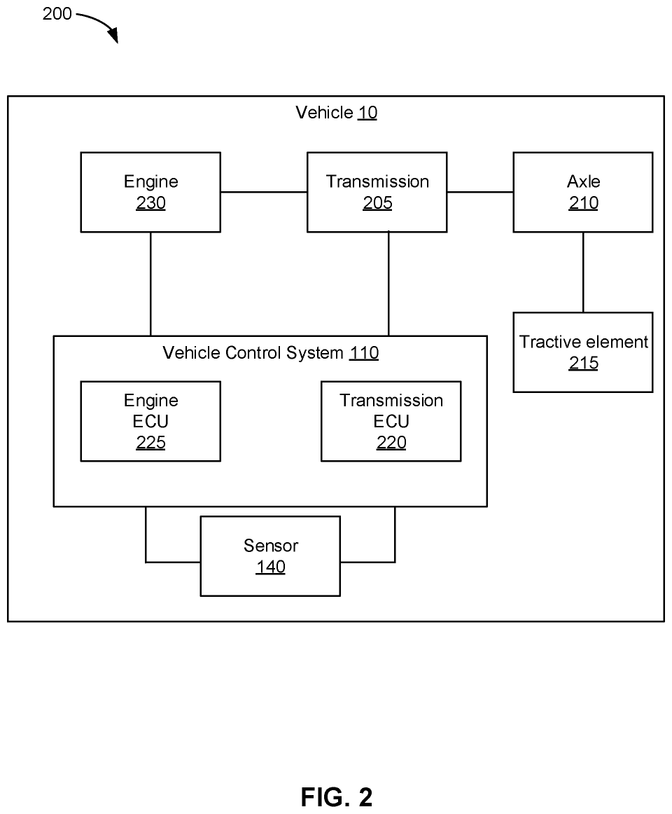

Referring to FIG. 2, a block diagram of a system 200 for controlling an agricultural vehicle is shown, according to an exemplary embodiment. The system 200 can include the vehicle 10. The vehicle 10 can include the vehicle control system 110, the sensor 140, at least one transmission 205, at least one axle 210, at least one tractive element 215 (e.g., wheels) and at least one engine 230.

The vehicle control system 110 can include a transmission electronic control unit (ECU) 220. In some embodiments, the transmission ECU 220 can perform similar functions to the parameter module 175 and/or the controller 180. For example, the transmission ECU 220 can receive an engine speed of the vehicle 10 from the sensor 140. The transmission ECU 220 can determine a difference between the engine speed and the desired engine speed. In some embodiments, the transmission ECU 220 can determine that the difference between the engine speed and the desired engine speed is larger than the engine speed threshold. The transmission ECU 220, responsive to determining that the difference between the engine speed and the desired engine speed is larger than the engine speed threshold, can control the transmission 205. For example, the transmission ECU 220 can control the transmission 205 to shift the transmission 205 to neutral.

The vehicle control system 110 can include an engine electronic control unit (ECU) 225. In some embodiments, the engine ECU 225 can perform similar functions to that of the parameter module 175 and/or the controller 180. For example, the engine ECU 225 can receive an engine temperature from the sensor 140. In some embodiments, the transmission ECU 220 and the engine ECU 225 can be combined as one unit. For example, the transmission ECU 220 can perform the same functionality as the engine ECU 225. In some embodiments, the transmission ECU 220 and the engine ECU 225 are both separate from the vehicle control system 110 and the transmission ECU 220 and the engine ECU 225 can communicate, via CAN, with each other.)

In some embodiments, the engine 230 can perform similar functionality to the primary mover 130. For example, the engine 230 can generate mechanical energy to operate the vehicle 10. The engine 230 can interface, interact or otherwise communicate the vehicle control system 110 and/or the transmission 205. The transmission 205 interface, interact or otherwise communicate with the engine 230, the vehicle control system 110 and/or the axle 210. The axle 210 can interface, interact or otherwise communicate with transmission 205 and/or the tractive element 215. The tractive element 215 can interface, interact or otherwise communicate with the axle 210.

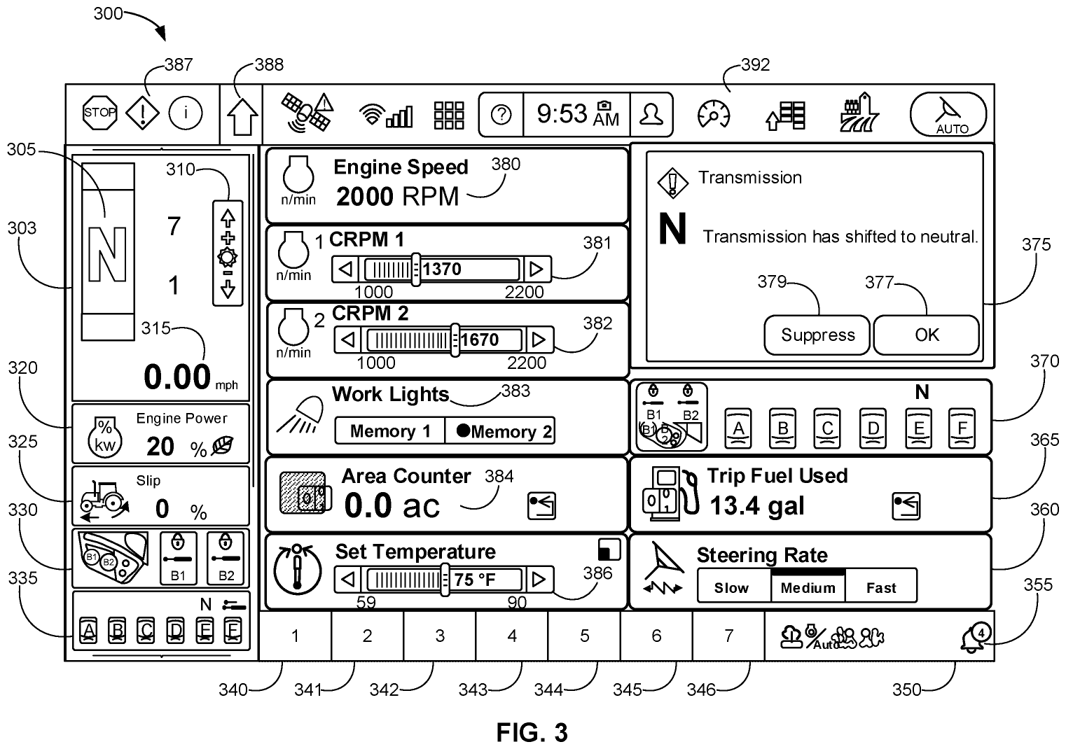

Referring now to FIG. 3, a user interface 300 is shown, according to an exemplary embodiment. In some embodiments, the information displayed, presented or otherwise provided by the user interface 300 can be the information that is generated by the vehicle control system 110. The user interface 300 can be displayed by the HMI 120. The user interface 300 can include a transmission information dashboard 303. The transmission information dashboard 303 can include a transmission gear icon 305, a transmission shifter icon 310 and a vehicle speed 315. In some embodiments, the transmission gear icon 305 can display the current gear of the transmission 205. For example, the transmission gear icon 305, as show in FIG. 3, is displaying that the transmission 205 is in neutral. The transmission shifter icon 310 can enable to operator of the vehicle 10 to control the transmission 205. For example, an operator of the vehicle 10 can select the transmission shifter icon 310. The HMI 120 can detect where on the transmission shifter icon 310 that the operator of the vehicle 10 selected. The HMI 120 can communicate with the controller 180 and/or the transmission ECU 220. For example, the HMI 120 can communicate to the controller 180 that the operator of vehicle 10 selected the first gear position. The controller 180, responsive to communicating with the HMI 120, can control the transmission 205 to shift to first gear.

The user interface 300 can include an engine power icon 320. The engine power icon 320 can display a current engine power (as a percentage) of the engine 230. The user interface 300 can include a slip icon 325. The slip icon 325 can display a current slip of the vehicle 10. The user interface 300 can include an icon 330. The icon 330 can display functions that relate to auxiliary valves. The user interface 300 can include icon 335. The icon 335 can display the current state of auxiliary paddles. The user interface 300 can include icons 340, 341, 342, 343, 344, 345 and 346. The icon 340 can be selected, by the operator of the vehicle 10, to shift the transmission 205 to first gear. The icon 341 can be selected, by the operator of the vehicle 10, to shift the transmission 205 to second gear. The icon 342 can be selected, by the operator of the vehicle 10, to shift the transmission 205 to third gear. The icon 343 can be selected, by the operator of the vehicle 10, to shift the transmission 205 to fourth gear. The icon 344 can be selected, by the operator of the vehicle to shift the transmission 205 to fifth gear. The icon 345 can be selected, by the operator of the vehicle 10, to shift the transmission 205 to sixth gear. The icon 346 can be selected, by the operator of the vehicle 10, to shift the transmission 205 to seventh gear. The user interface 300 can include a dashboard 350. The dashboard 350 can include an alert icon 355. The alert icon 355 can be selected, by the operator of the vehicle 10, to view at least one alert that is associated with the vehicle 10. In some embodiments, the alerts can include at least one alert that the vehicle 10 has shifted to neutral. In some embodiments, the alerts will be provided as an overlay to user interface 300. In some embodiments, a subsequent user interface can be generated.

The user interface 300 can include a steering rate dashboard 360. The steering rate dashboard 360 can include a current steering rate of the vehicle 10. For example, the steering rate, as shown in FIG. 3, has been selected to medium. The user interface 300 can include a trip fuel dashboard 365. The trip fuel dashboard 365 can include an amount of fuel used by the vehicle 10. For example, the trip fuel used, as shown in FIG. 3, is 13.4 gallons. The user interface 300 can include an icon 370. The icon 370 can include similar information to that of icons 330 and 335. The user interface 300 can include a transmission alert 375. The transmission alert 375 can display, as shown in FIG. 3, an alert that the transmission 205 has shifted to neutral. An operator of the vehicle 10 can select an OK icon 377 and/or a suppress icon 379. In some embodiments, the operator of the vehicle 10 can select the OK icon 377 to remove the transmission alert 375. In some embodiments, the transmission alert 375, upon selection of the OK icon 377, can be replaced with additional information that pertains to the vehicle 10. For example, the transmission alert 375 can be replaced with a dashboard that displays a total number of transmission shifts to neutral.

The user interface 300 can include an engine speed dashboard 380. The engine speed dashboard 380 can display an engine speed of the engine 230. For example, the engine speed dashboard 380, as shown in FIG. 3, displays the engine speed as 2000 RPM. The user interface 300 can include an icon 381. The icon 381 can include information that pertains to a selected value for a first constant engine RPM value. The user interface 300 can include icon 382. The icon 382 can include information that pertains to a selected value for a second constant engine RPM value. The user interface 300 can include a work lights icon 383. The work lights icon 383 can indicate a current state of the lights associated with the vehicle 10. For example, the work lights icon 383 can indicate if the lights are on or off. The user interface 300 can include an area counter dashboard 384. The area counter dashboard 384 can display an amount of area covered by the vehicle 10. For example, the area counter dashboard 384, as shown in FIG. 3, displays that amount of area covered is zero acres. The user interface 300 can include a temperature icon 386. The operator of the vehicle 10 can adjust the temperature of the vehicle 10 by selecting the temperature icon 386.

The user interface 300 can include a warning icon 387. In some embodiments, selecting the warning icon 387 can result in similar actions to that of selecting the alert icon 355. For example, an operator of the vehicle 10 can select the alert icon 355 to view at least one alert that is associated with the vehicle 10. In some embodiments, the alerts can include at least one alert that the vehicle 10 has shifted to neutral. In some embodiments, the alerts will be provided as an overlay to user interface 300. In some embodiments, a subsequent user interface can be generated. The user interface 300 can include an icon 388. The icon 388 can show a current position of a tool. For example, the icon 388 can show that a hitch is in a first position. The user interface 300 can include an icon 392. The icon 392 can show other user interfaces that can be accessed by touching various locations pertaining to the icon 392.

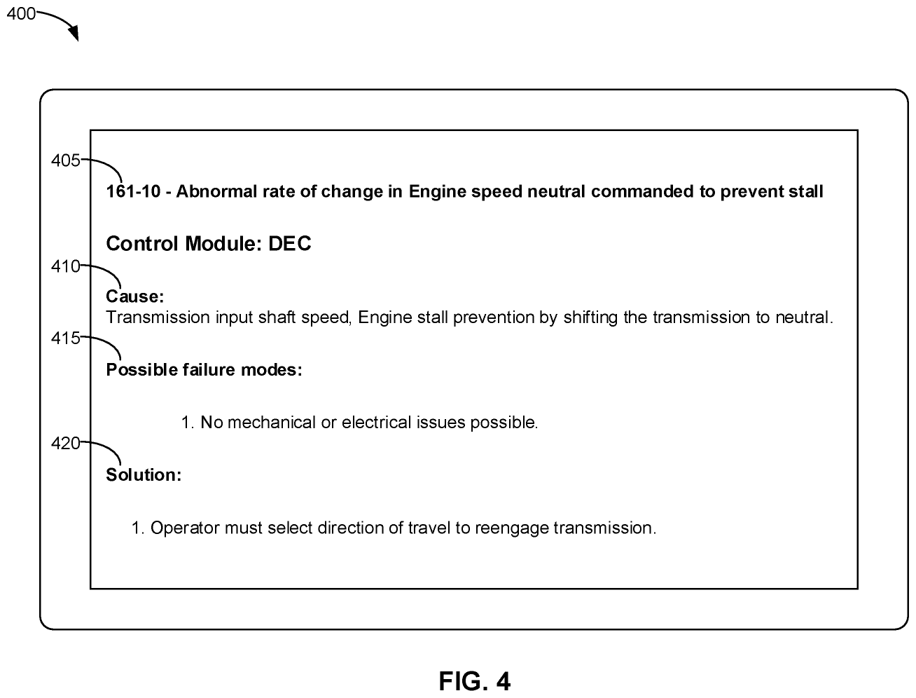

Referring now to FIG. 4, a user interface 400 is shown, according to an exemplary embodiment. In some embodiments, the information displayed, presented or otherwise provided by the user interface 400 can be the information that is generated by the vehicle control system 110. The user interface 400 can be displayed by the HMI 120. In some embodiments, the user interface 400 can be generated responsive to an operator of the vehicle selecting the alert icon 355 and/or the warning icon 387.

The user interface 400 can include information that pertains to a shift to neutral of the vehicle 10. For example, the user interface 400 can include an alert code 405. The alert code 405 can include information that pertains to a particular parameter for the vehicle 10. For example, the alert code 405, as shown in FIG. 4, can include that there was an abnormal rate of change in engine speed and that a shift to neutral was commanded to prevent a vehicle stall. The user interface 400 can include a cause display 410. The cause display 410 can provide a cause for the alert code 405. For example, the cause display 410, as shown in FIG. 4, can include that the transmission input shaft speed (e.g., the engine speed) was the cause of the alert code 405. The user interface 400 can include a failure mode 415. The failure mode 415 can provide a possible failure that may have caused the alert code 405. For example, the failure mode 415, as shown in FIG. 4, can include that no mechanical or electrical issues are possible. The user interface 400 can include a solution display 420. The solution display 420 can include an action, based on the alert code 405, that can be taken by the operator of the vehicle 10. For example, the solution display 420, as shown in FIG. 4, can include that the operator must select direction of travel to reengage the transmission.

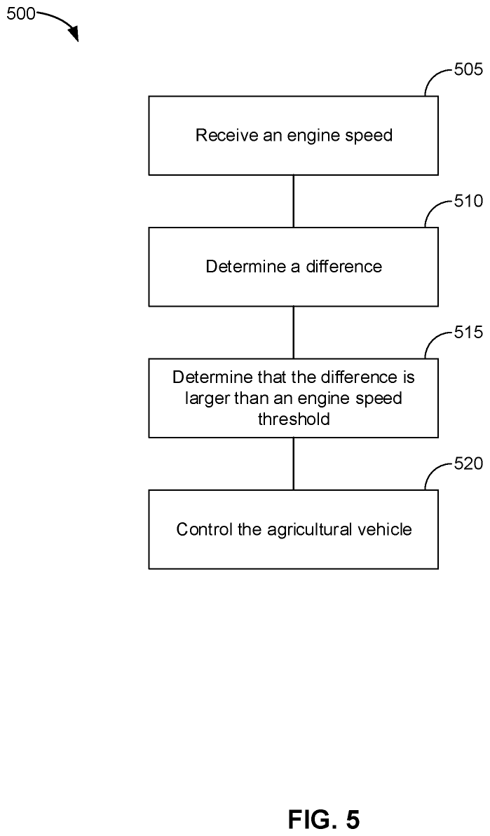

Referring now to FIG. 5, a block diagram of a process 500 for controlling an agricultural vehicle is shown, according to an exemplary embodiment. In some embodiments, the agricultural vehicle can be the vehicle 10 described herein. In some embodiments, at least one step of the process 500 can be performed by the vehicle control system 110 and/or by a component of the vehicle control system 110.

In step 505, the vehicle control system 110 can receive an engine speed. For example, the parameter module 175 can receive the engine speed from the sensor 140. In some embodiments, the engine speed received in step 505 can be an engine speed of an agricultural vehicle (e.g., the vehicle 10). The sensor 140 can be placed proximate to the engine 230 and the sensor 140 can detect, collect or otherwise determine an engine speed of the engine 230. In some embodiments, the sensor 140 can be remote to the engine 230 and the engine 230 can provide signals to the sensor 140. The sensor 140 can determine, using the signals provided by the engine 230, the engine speed of the engine 230.)

In step 510, the vehicle control system 110 can determine a difference. For example, the parameter module 175 can determine the difference by comparing the engine speed received in step 505 with a desired engine speed. In some embodiments, the parameter module 175 can communicate with the parameter database 170. The parameter database 170 can provide, responsive to communicating with the parameter module 175, the desired engine speed to the parameter module 175. The parameter module 175 can determine the difference between the engine speed received in step 505 and the desired engine speed provided by the parameter database 170.

In step 515, the vehicle control system 110 can determine that the difference is larger than an engine speed threshold. In some embodiments, parameter module 175 can determine that the difference that was determine in step 510 (e.g., the difference between the engine speed received in step 505 and the desired engine speed) is larger than the engine speed threshold. In some embodiments, the engine speed threshold can be provided, by the parameter database 170, to the parameter module 175 in step 510. In some embodiments, the parameter module 175 can communicate, responsive to determining the difference between the engine speed and the desired engine speed, for a second time with the parameter database 170. The parameter database 170 can provide the engine speed threshold responsive to communicating with the parameter module 175 for the second time.

In step 520, the vehicle control system 110 can control the agricultural vehicle. For example, the controller 180 can receive, from the parameter module 175, an indication that difference between the engine speed and the desired engine speed is larger than the engine speed threshold. In some embodiments, the controller 180 can, responsive to receiving the indication, control the vehicle 10 to shift to neutral. In some embodiments, the controller 180 can provide, to the parameter module 175 and/or the sensor 140, an indication that the vehicle 10 has be shifted to neutral. In some embodiments, the parameter module 175 can receive, from the sensor 140, a second engine speed. The parameter module 175 can compare the second engine speed with the desired engine speed.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein.

What is claimed is:

1. A vehicle control system for an agriculture vehicle, the system comprising:
a processing circuit including a processor and memory, the memory having instructions stored thereon that, when executed by the processor, cause the processing circuit to:
receive an engine speed of the agricultural vehicle;
determine a difference between the engine speed and a desired engine speed;
determine whether the difference is larger than an engine speed threshold; and
control, responsive to the difference being larger than the engine speed threshold, the agricultural vehicle to shift to neutral.

2. The vehicle control system of claim 1, wherein the processing circuit is configured to:
receive, after the shift to neutral, a second engine speed;
determine a difference between the second engine speed and the desired engine speed;
determine whether the difference is larger than the engine speed threshold; and
prevent, responsive to the difference being larger than the engine speed threshold, the agricultural vehicle from being shifted out of neutral.

3. The vehicle control system of claim 1, wherein the processing circuit is configured to:
present, using a user interface, an alert that the agricultural vehicle has shifted to neutral; and
present, using the user interface, an indication, wherein the indication includes information pertaining to the shift to neutral.

4. The vehicle control system of claim 1, wherein the processing circuit is configured to:
present, using a user interface, an alert that the agricultural vehicle has shifted to neutral;
receive, using the user interface, an input to override the shift to neutral; and
control, responsive to receiving the input, the agricultural vehicle to shift from neutral.

5. The vehicle control system of claim 1, wherein the processing circuit is configured to:
detect a change in the engine speed of the agricultural vehicle;
determine a difference between the engine speed and the desired engine speed; and
control, responsive to the difference being smaller than the engine speed threshold, the agricultural vehicle to shift from neutral.

6. The vehicle control system of claim 1, wherein the processing circuit is configured to:
receive a parameter associated with the environment of the agricultural vehicle; and
adjust, based on the parameter, the desired engine speed.

7. The vehicle control system of claim 6, wherein the parameter is associated with at least one of an air pressure, an air temperature, or an air humidity.

8. The vehicle control system of claim 1, wherein the processing circuit is configured to:
receive a parameter associated with the agricultural vehicle; and
control, responsive to receiving the parameter, the agricultural vehicle to shift to neutral.

9. The vehicle control system of claim 8, wherein the parameter is associated with at least one of an oil temperature, a vehicle idle time, or engine temperature.

10. The vehicle control system of claim 8, wherein the processing circuit is configured to:
detect a change in the parameter; and
control, responsive to detecting the change in the parameter, the agricultural vehicle to shift from neutral.

11. A method of controlling an agricultural vehicle, the method comprising:
receiving, by a processing circuit, an engine speed of the agricultural vehicle;
determining, by the processing circuit, a difference between the engine speed and a desired engine speed;
determining, by the processing circuit, whether the difference is larger than an engine speed threshold; and
controlling, by the processing circuit, responsive to the difference being larger than the engine speed threshold, the agricultural vehicle to shift to neutral.

12. The method of claim 11, comprising:
receiving, by the processing circuit, after the shift to neutral, a second engine speed;
determining, by the processing circuit, a difference between the second engine speed and the desired engine speed;
determining, by the processing circuit, whether the difference is larger than the engine speed threshold; and
preventing, by the processing circuit, responsive to the difference being larger than the engine speed threshold, the agricultural vehicle from being shifted out of neutral.

13. The method of claim 11, comprising:
presenting, by the processing circuit, using a user interface, an alert that the agricultural vehicle has shifted to neutral; and
presenting, by the processing circuit, using the user interface, an indication, wherein the indication includes information pertaining to the shift to neutral.

14. The method of claim 11, comprising:
presenting, by the processing circuit, using a user interface, an alert that the agricultural vehicle has shifted to neutral;
receiving, by the processing circuit, using the user interface, an input to override the shift to neutral; and
controlling, by the processing circuit, responsive to receiving the input, the agricultural vehicle to shift from neutral.

15. The method of claim 11, comprising:
detecting, by the processing circuit, a change in the engine speed of the agricultural vehicle;
determining, by the processing circuit, a difference between the engine speed and the desired engine speed; and
controlling, by the processing circuit, responsive to the difference being smaller than the engine speed threshold, the agricultural vehicle to shift from neutral.

16. The method of claim 11, comprising:
receiving, by the processing circuit, a parameter associated with the environment of the agricultural vehicle; and
adjusting, by the processing circuit, based on the parameter, the desired engine speed.

17. The method of claim 11, comprising:
receiving, by the processing circuit, a parameter associated with the agricultural vehicle; and
controlling, by the processing circuit, responsive to receiving the parameter, the agricultural vehicle to shift to neutral.

18. The method of claim 17, comprising:
detecting, by the processing circuit, a change in the parameter; and
controlling, by the processing circuit, responsive to detecting the change in the parameter, the agricultural vehicle to shift from neutral.

19. A non-transitory computer-readable storage medium having instructions stored thereon that, when executed by a processor, cause the processor to:
receive an engine speed of the agricultural vehicle;
determine a difference between the engine speed and a desired engine speed;
determine whether the difference is larger than an engine speed threshold; and
control, responsive to the difference being larger than the engine speed threshold, the agricultural vehicle to shift to neutral.

20. The non-transitory computer-readable storage medium of claim 19, wherein the processor is configured to:
receive, after the shift to neutral, a second engine speed;
determine a difference between the second engine speed and the desired engine speed;
determine whether the difference is larger than the engine speed threshold; and
prevent, responsive to the difference being larger than the engine speed threshold, the agricultural vehicle from being shifted out of neutral.
